(19) United States
(12) Patent Application Publication
(10) Pub. No.: US 2013/0317911 A1
(43) Pub. Date: Nov. 28, 2013

(54) Real-Time Advertisement Negotiation

(71) Applicant: Jiri Medlen, Campbell, CA (US)

(72) Inventor: Jiri Medlen, Campbell, CA (US)

(73) Assignee: eBay, Inc., San Jose, CA (US)

(21) Appl. No.: 13/481,165

(22) Filed: May 25, 2012

(51) Int. Cl. G06Q 30/02

(52) U.S. Cl. 705/14.58

(57) ABSTRACT

Methods and systems are disclosed for providing advertisements to consumers when the consumers are proximate the physical location of the advertising merchant. Negotiation of prices/discounts can be facilitated. A user can be provided with an advertisement via a mobile device of the user while walking past a store. The advertisement can include a price/discount. The user can respond to the advertisement by proposing a price/discount that is more favorable to the user. This process can repeat indefinitely. If agreement is reached regarding the price/discount, then the user can enter the store and make the purchase.

### BACKGROUND

1. Technical Field

The present disclosure generally relates to electronic commerce and, more particularly, relates to a system and method for facilitating real-time advertisement and negotiation when a user is near a merchant.

2. Related Art

The use of advertising to entice consumers to make purchases is well known. Typically, a consumer will read, view, or listen to an advertisement while in a location that is substantially far away from the location of the advertising merchant. That is, the consumer will not be near the merchant. For example, the consumer may be watching television at home when an advertisement for a particular merchant is aired and the merchant may be many miles away from the consumer's home.

Later, when the same consumer is at or near the store for which the advertisement aired, enough time may have passed for the advertisement to have been forgotten. Thus, the impact of an advertisement can be substantially reduced over time. Of course, such reduction in the impact of an advertisement is undesirable for the merchant who paid to have the advertisement aired on television.

### SUMMARY

Methods and systems are disclosed for exposing consumers to advertisements when the consumers are near the advertising merchants, according to an embodiment. In this manner, the consumers have an opportunity to purchase advertised products before the impact of the advertisement has been substantially reduced by the passage of time. Methods and systems are disclosed for facilitating negotiations between consumers and merchants, according to an embodiment. Such negations can provide a better price for the consumer and can provide a customer that would otherwise have been lost for the merchant.

According to one or more embodiments, methods and systems are disclosed for providing advertisements to consumers when the consumers are at or near a physical location of the advertising merchant. Negotiation between the user and the merchant of prices and/or discounts can be facilitated. For example, a system can include a memory that stores account information for a user in a user account. The account information can include an indication of a desire of the user to receive advertisements from one or more merchants when the user is near or proximate the merchant(s). A processor can receive a communication that includes an indication of the user being near one of the merchants. The communication can also include information regarding an advertisement from the merchant. The processor can access the user account, determine from the user account if the user has indicated a desire to receive the advertisement, and facilitate communication of the advertisement to the user if the user desires to receive the advertisement.

According to an embodiment, the processor can be operable to facilitate price/discount negotiations on behalf of the user and/or the processor can be operable to facilitate price/discount negotiations on behalf of the merchant. The processor can be operable to facilitate price/discount negotiations on behalf of both the user and the merchant.

According to an embodiment, the account information can specify from what merchants the user desires to receive advertisements, for what products the user desires to receive advertisements, from what merchant locations the user desires to receive advertisements, and/or at what times the user desires to receive advertisements. For example, the user can specify that the user is only to receive advertisements from pizza restaurants for pepperoni pizzas from 11:00 AM to 12:30 PM on Monday through Friday and within the city limits of Irvine, Calif.

According to an embodiment, the advertisement can be communicated to the user via a text message, an SMS text message, an MMS text message, an email, and/or a voice message. The advertisement can be communicated to the user by any desired method or combination of methods.

According to an embodiment, the user can be invited to view a web site of the merchant. The invitation can be communicated to the user via a text message, an SMS text message, an MMS text message, an email, and/or a voice message. The invitation can be communicated to the user by any desired method or combination of methods.

According to an embodiment, the system can be implemented by a payment provider, such as Paypal, Inc. Thus, the memory can be a memory of a payment server and the processor can be a processor of the payment server.

According to an embodiment, the processor can access a merchant account, determine from the merchant account if the merchant is presently open, and communicate the advertisement to the user only when the merchant is presently open. The processor can access a merchant account, determine from the merchant account if the merchant is presently open, and communicate the advertisement to the user whether the merchant is presently open or closed. The processor can include in the advertisement, particularly when the merchant is closed, the hours during which the merchant is open.

According to an embodiment, the advertisement can be communicated to a mobile device of the user. For example, the advertisement can be communicated to an app of a smart phone of the user.

### BRIEF DESCRIPTION OF THE DRAWINGS

FIG. 1 is a block diagram of a system for real-time advertisement and negotiation, in accordance with an embodiment;

FIG. 2 is a flow chart showing a method for real-time advertisement and negotiation, in accordance with an embodiment;

FIG. 3 is a flow chart showing further detail of the method for real-time advertisement and negotiation, in accordance with an embodiment; and

FIG. 4 is a block diagram of an example of a computer that is suitable for use in the system for real-time advertisement and negotiation, in accordance with an embodiment.

### DETAILED DESCRIPTION

Methods and systems are disclosed for exposing a consumer to an advertisement of a merchant before or at approximately the same time that the consumer is at or near, e.g., is proximate, a location of the merchant. Thus, real-time advertisement can be provided. In this manner, the consumer has an opportunity to purchase the advertised product before the impact of the advertisement has been substantially reduced by the passage of time. Methods and systems are disclosed for facilitating negotiation of an incentive, e.g., a price/discount for the advertised product. The price/discount can be negotiated prior to the user entering a store of the merchant. Such negotiation can entice the customer to enter the store can make the purchase.

According to an embodiment, the system can facilitate a negotiation of the price/discount on behalf of the user, can facilitate a negotiation of the price/discount on behalf of the merchant, and/or can facilitate a negotiation of the price/discount on behalf of both the user and the merchant. Thus, the user and merchant can actively participate in the negotiation. Thus, the negotiation can be substantially invisible (behind the scenes) to either or both of the user and the merchant.

The negotiation can be performed manually. The user and/or the merchant can actively participate in the negotiation. For example, the merchant can manually enter a price/discount before the advertisement is provided to the user and/or the user can manually enter a counter offer of the price/discount to be communicated to the merchant. A portion of the negotiation (one or more iterations of the negotiation) can be performed automatically and a portion of the negotiation can be performed manually.

During a user setup procedure, the user can provide user account information. For example, the user account information can specify from what merchants the user desires to receive advertisements, for what products the user desires to receive advertisements, at what merchant locations the user desires to receive advertisements, and at what times/dates the user desires to receive advertisements. The user can also specify how much of a discount is required by the user.

During a merchant setup procedure, the merchant can provide merchant account information. For example, the merchant account information can specify when (such as dates, days of the week, time of day, etc.) special prices or discounts are to be provided and for which products the special prices or discounts are to be provided. The merchant can have a plurality of stores. If the merchant has a plurality of stores, then such times and products can be different for each store.

The advertisement can be communicated to the user via a text message, such as an SMS text message or an MMS text message. The advertisement can be communicated to the user via email. The advertisement can be communicated to the user via a voice message (such as via a cellular telephone network). The user can be invited to view a web site of the merchant.

The system can determine from information in the merchant account if the merchant is presently open. The system can communicate the advertisement to the user only when the merchant is open.

The system can communicate the advertisement to the user when the merchant is not open. When the merchant is not open, the advertisement can state when the merchant will be open. For example, if the merchant will open in ten minutes, then the system can communicate the advertisement to the user and can state that the merchant will be open in ten minutes. The system can communicate the advertisement to the user when the merchant is not open and can include in the advertisement the hours during which the merchant is open.

The advertisement can be communicated to a mobile device of the user. The advertisement can be communicated to an app of a mobile device of the user. For example, the advertisement can be communicated via the Internet to a smart phone or other mobile device of the user. Similarly, the advertisement can be communicated via cellular telephone network to a smart phone or other mobile device of the user.

The advertisement can be sent directly from the merchant to the user. The advertisement can be sent from the merchant to an intermediary (such as a payment server of a payment provider) and then from the intermediary to the user.

According to an embodiment, a processor can receive a communication that includes an indication of the user being near one of the merchants. For example, the communication can be from a merchant device to the processor of a payment server. The communication can also include information regarding an advertisement from the merchant. The processor can access the user account, determine from the user account if the user has indicated a desire to receive a advertisement, and facilitate communication of the advertisement to the user if the user account indicates that user desires to receive the advertisement.

The indication of the user being near the merchant can be the same information as the information regarding an advertisement. Thus, a single code can indicate to the payment server that the user is near the merchant and that the merchant desires to send an advertisement. For example, the advertisement itself can be the indication of the user being near the merchant. That is, the sending of the advertisement, such as from the merchant to the payment server, can indicate to the payment server that the user is near the merchant.

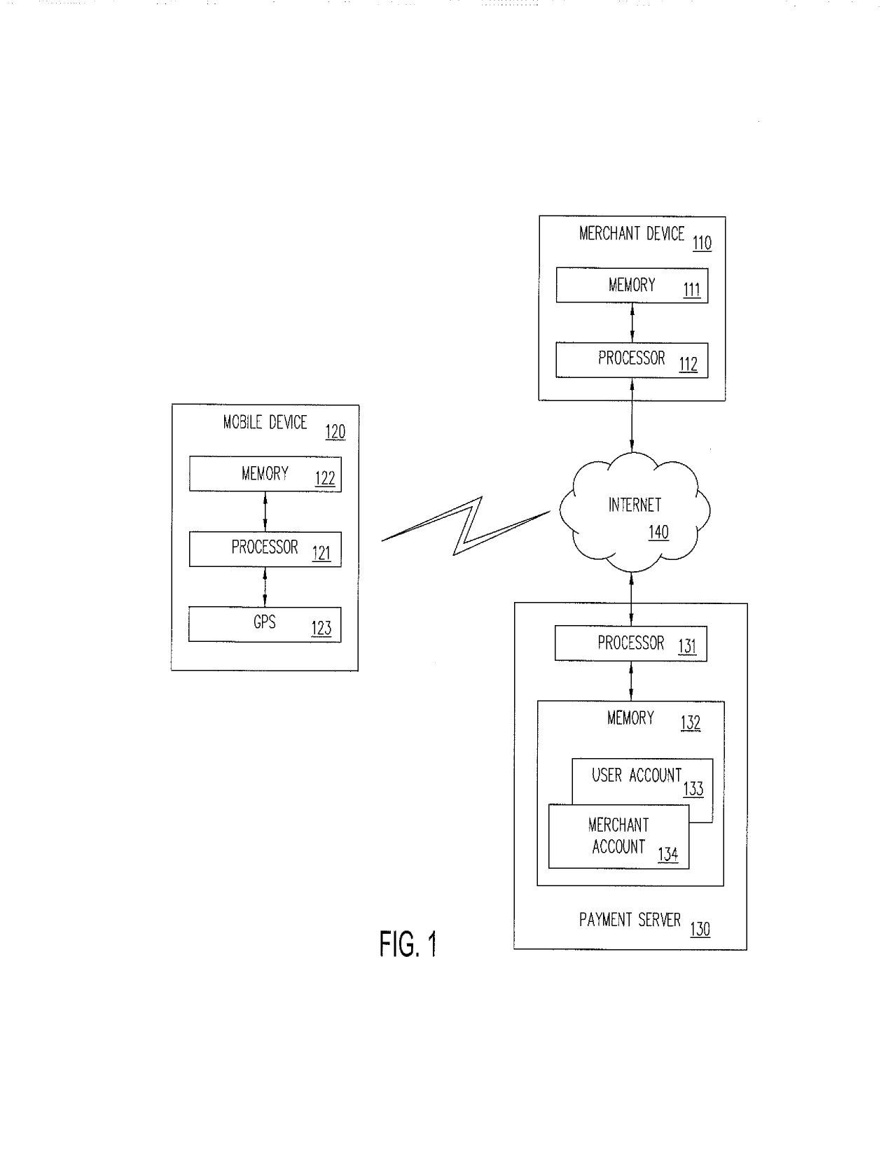

FIG. 1 is a block diagram of a system for real-time advertisement and negotiation, in accordance with an embodiment. The system can include a merchant device 110. The merchant device 110 can be a merchant checkout terminal, a computer, and/or a server, for example. The merchant device 110 can include a memory 111 and a processor 112.

The system can include a mobile device 120. The mobile device 120 can be carried by the user. The mobile device 120 can be a cellular telephone, a smart telephone, a hand held computer, or a tablet computer, for example. The mobile device can include a processor 121, a memory 122, and a global positioning system (GPS) 123.

The system can include a payment server 130. The payment server can be a server of a payment provider, such as Paypal, Inc. The payment server 130 can be a single server or can be a plurality of servers. The payment server 130 can include a processor 131 and a memory 132. The memory 132 can store a user account 133 and a merchant account 134.

The processor 131 and the memory 132 can cooperate to define a negotiation engine. The negotiation engine can negotiate on behalf of the user and/or on behalf of the merchant. The negotiation engine can function as a mediator between the user and the merchant. For example, the negotiation engine can provide a compromise of the price/discount. The compromise can be within predetermined limits for both the user and the merchant. For example, the merchant may specify a minimum acceptable price or maximum discount for an item or type of item, and the user may specify a maximum acceptable price or a minimum discount for an item or type of item. Thus, the negotiation engine can negotiate a price/discount that is acceptable to both the user and the merchant. Of course, such negotiation by the negotiation engine tends to benefit both the user and the merchant.

The merchant device 110, the mobile device 120, and the payment server 130 can communicate with one another via a network, such as the Internet 140. The merchant device 110, the mobile device 120, and the payment server 130 can communicate with one another via a plurality of networks, such as local area networks (LANs), wide area networks (WANs), cellular telephone networks, and the like.

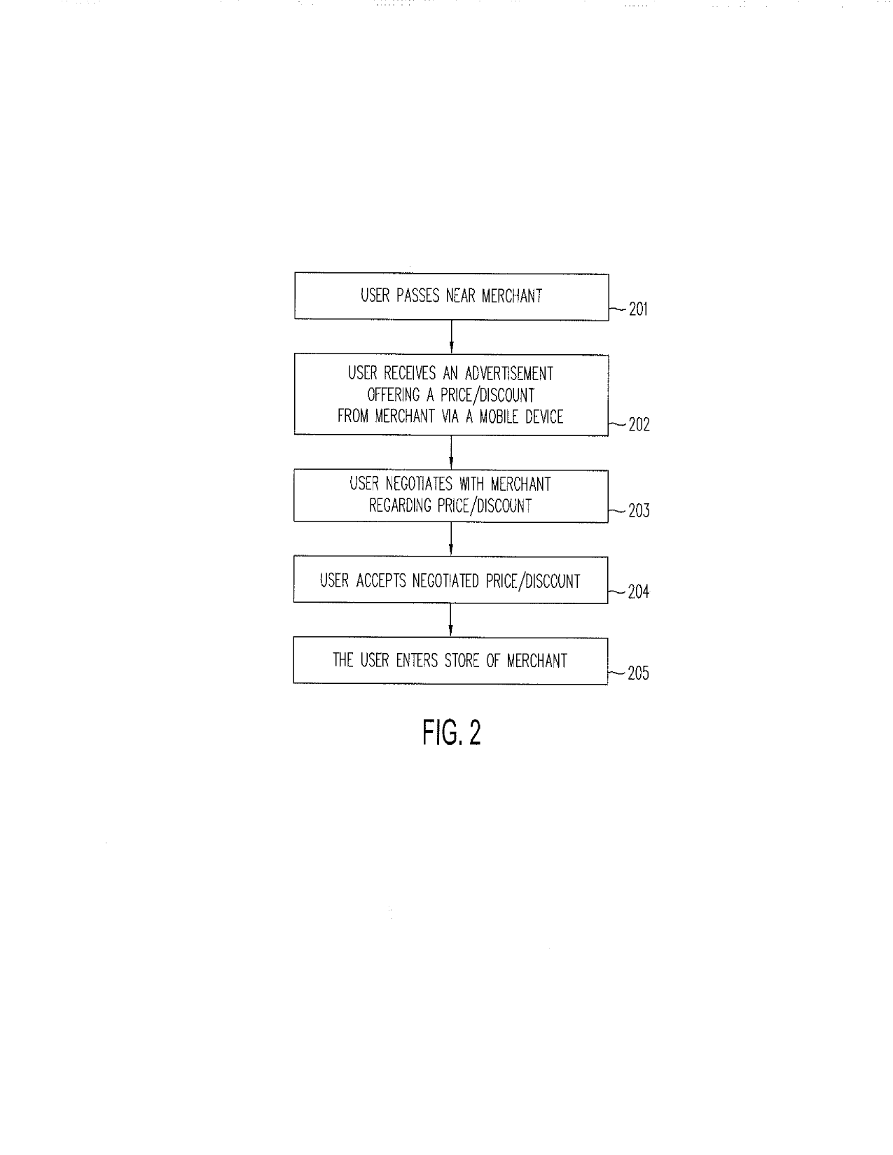

FIG. 2 is a flow chart showing a method for real-time advertisement and negotiation, in accordance with an embodiment. A user can pass near a merchant, as shown in step 201. The user can be walking or in a car, for example. The user can be walking down a sidewalk or walking in a mall, for example. “Near” may be defined by the system, the merchant, and/or the user. For example, the system may determine that the user is near a merchant when the user gets within one mile, 500 yards, etc. of a merchant. The distance may vary depending on location, such as if the user is in a densely populated shopping area like a mall or in a rural location where stores are spaced far apart.

The user can be within WiFi, WiMAX, or other wireless network data communication range of the merchant. The advertisement and subsequent communication, e.g., the negotiation, between the user and the merchant can be via such wireless network data communication. For example, the merchant device 110 can broadcast a WiFi signal that is received by the mobile device 120 and operated upon by an app of the mobile device 120.

The user can be within range of a cellular telephone network. The advertisement and subsequent communication, e.g., the negotiation, between the user and the merchant can be via the cellular telephone network. For example, the GPS 123 of the mobile device 120 can cooperate with the processor 121 and the memory 122 to notify the merchant device 110 that the user (more particularly, the mobile device 120 of the user) is near the merchant. Thus, the GPS 123 can provide location information for the mobile device 120 and when the mobile device is near a merchant location that is stored in the memory 122, then the processor 121 can operate to communicate with the merchant device 110 and the merchant device 110 can respond by communicating the advertisement to the mobile device 120.

While near the merchant, the user can receive an advertisement or incentive from the merchant, as shown in step 202. The advertisement can offer a reduced price or a discount to the user. The price/discount can be for specific, listed items. The price/discount can be for a wide range of items, which need not be listed individually. For example, the price/discount can be for all meals served between 1:00 PM and 5:00 PM on that day.

The advertisement can be received via the mobile device 120. The mobile device can alert the user by ringing, buzzing, providing a ring tone, vibrating, illuminating, or by any other method. The user can view and/or listen to the advertisement via the mobile device 120. The user can view and/or listen to the advertisement via different device from the device with which the user was alerted. For example, the user can be alerted to the advertisement via the mobile device 120 and can view the advertisement via a tablet computer, a display of the merchant, or any other device.

The user can be alerted to view a device or display that is not a device or display of the user. For example, if the user is near a device or display of the merchant, then the user can be alerted by the user device 120 and instructed to view the device or display of the merchant. The device or display of the merchant can list or advertise specials of the merchant.

The mobile device 120 can be configured to receive communications from the merchant device 110. For example, the mobile device 120 can be configured to receive communications from the merchant device 110 via WiFi, WiMAX, a cellular telephone network, or any other method.

The user can negotiate with the merchant regarding the price/discount offered in the advertisement, as shown in step 203. For example, the merchant can provide the user with an advertisement that offers 10% off on lunch specials. The user can counter offer by requesting that the discount be 20%. The merchant can then either accept the counter offer, provide a new offer, or end negotiations without accepting the counter offer or providing a new offer. The communication between the merchant and user may be handled by or through the service provider.

Rather than providing a counter offer, the user can simply reject any offer. The user can reject the offer explicitly, such by communicating rejection of the offer via the mobile device 120. The user can reject the offer implicitly, such as by not accepting the offer.

If the user rejects the offer without providing a counter offer, the merchant can provide a new offer. The merchant can provide such new offers indefinitely. Thus, the merchant can continue to increase the discount or lower the price until the user either accepts the offer, indicates that the negotiation is terminated, or moves away from the merchant (such as out of WiFi or WiMAX range of the merchant).

The merchant can manually provide the offer, accept the counter offer, and/or provide the new offer. Thus, a person can manually provide the offer, accept the counter offer, and/or provide the new offer.

The merchant device 110 can automatically provide the offer, accept the counter offer, and/or provide the new offer. Thus, a machine can automatically provide the offer, accept the counter offer, and/or provide the new offer.

The merchant device 110 can be preset to automatically provide different offers at different times. For example, the merchant device 110 of a restaurant can be preset to automatically advertise an offer of 10% off all lunch specials on Monday through Friday from 11:00 AM to 1:00 PM, to advertise an offer of 20% off all meals on Monday through Friday from 1:00 to 6:00 PM, and to advertise an offer of 30% off of selected dinners after 6:00 PM on Mondays through Wednesdays. Thus, the merchant can provide greater discounts to better entice customers into the restaurant during times when the restaurant is less busy.

The negotiation process can be at least partly manual. Thus, a person, e.g., the user and/or the merchant, can perform at least part of the negotiation. The negotiation process can be fully manual, with the user entering a new offer, the merchant viewing the new offer and accepting or providing a different offer by manual entry, etc.

The negotiation process can be at least partly automatic. Thus, a machine, e.g., the mobile device 120, the merchant device 110, and/or the payment server 130, can perform at least part of the negotiation. The negotiation process can be fully automated.

Such automation can include the user and/or the merchant setting rules and limits for the price/discount. For example, the rules provided by the merchant can include the following:
Every weekday, advertise 10% off of all lunch specials;
Accept counter offers up to 20% off for all beef lunch specials;
Accept counter offers up to 25% off for all fish lunch specials; and
Accept counter offers up to 30% off for all chicken lunch specials.

For example, the rules provided by the user can include the following:
Negotiate all lunch special advertisements to the lowest price that the merchant accepts; and
Notify the user of any lunch specials that originally have or are negotiated to have a discount of at least 20%.

The user can accept the offered price/discount, as shown in step 204. The user can accept or reject any offer or new offer made by the merchant. If the user accepts the offered price/discount (with or without negotiation), the user can enter the store and purchase the advertised product, as shown in step 205.

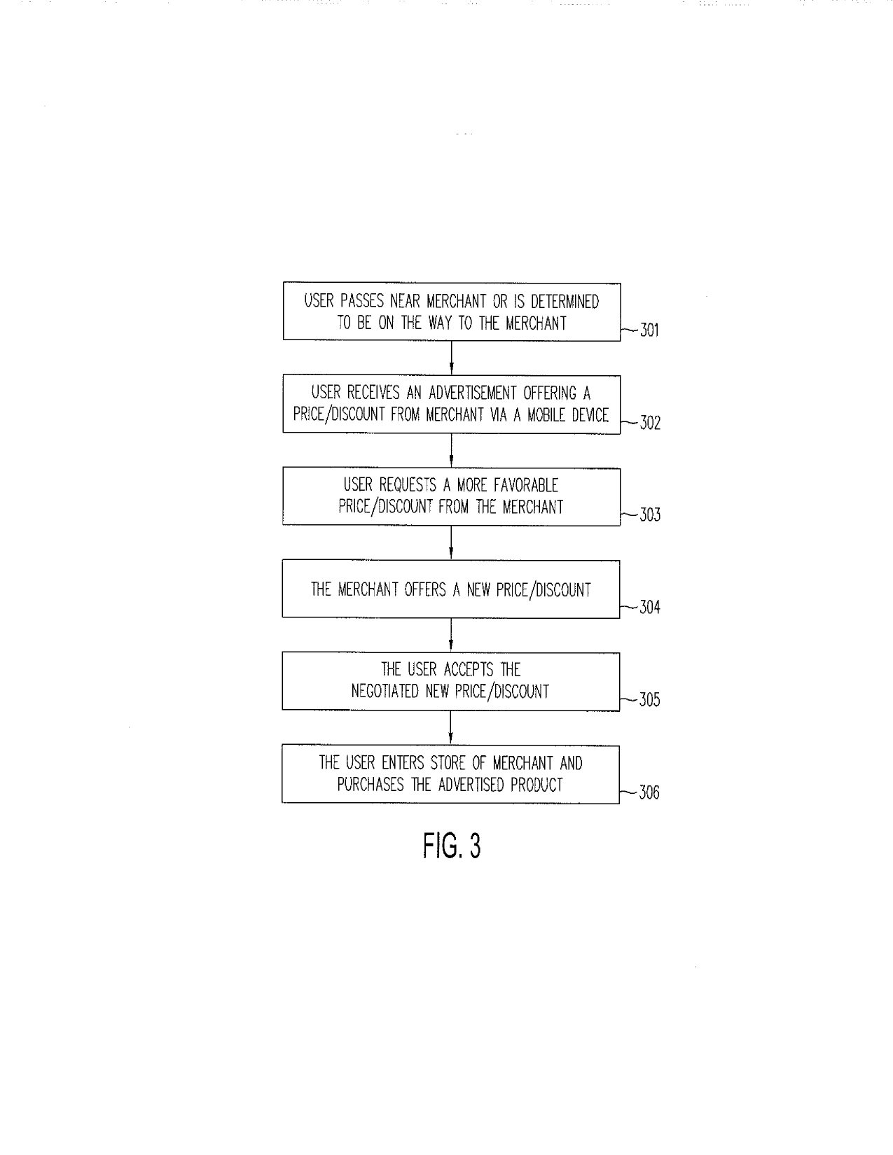

FIG. 3 is a flow chart showing further detail of the method for real-time advertisement and negotiation, in accordance with an embodiment. The user can pass near the merchant or can be determined to likely be on the way to the merchant, as shown in step 301. The user can be determined to likely be on the way to the merchant when the user is following a path that is likely to lead to the merchant. This can be done on a statistical basis. Thus, although movement of the user may often be a substantially stochastic process from the viewpoint of the merchant, a prediction that the user will pass near the merchant can generally be made with reasonable accuracy before the user is actually near the merchant. In many cases, such a prediction is possible blocks or miles before the user is near the merchant.

For example, the user can be traveling by car down a main road that has one intersection with a cross street between the user and the merchant. If the cross street is used much less that the main road, then it can be likely, based on statistics, that the user will stay on the main road and pass by the merchant. Therefore, the advertisement can be sent to the user. The merchant device 110 or the payment server 130 can determine whether or not a user is statistically likely to pass near a merchant and can initiate sending of the advertisement from the merchant device 110.

The user can receive the advertisement, as discussed above and shown in step 302. If the user is not near the merchant when the advertisement is received, the user can utilize the time prior to reaching the location of the merchant to decide whether or not to accept the offer provided in the advertisement and/or to negotiate a better price/discount than what is initially offered in the advertisement.

The user can counter offer by requesting a more favorable price/discount than what is initially offered in the advertisement, as shown in step 303. The merchant can then accept the user's counter offer. Alternatively, the merchant can reject the user's counter offer and take no further action. Alternatively, the merchant can offer a new price/discount from that of the user's counter offer, as shown in step 304. The user can then accept or reject the merchant's new price/discount, as shown in step 305. If the user accepts the merchant's new price/discount, then the user can enter the store and purchase the advertised product, as shown in step 306.

For example, a user can be walking down a sidewalk and pass near a restaurant. The restaurant can provide the user with an advertisement for a special price or discount on a meal. The advertisement can be provided via a mobile device of the user while the user is still near the restaurant. The advertisement can include a price/discount. The user can respond to the advertisement by proposing a price/discount that is more favorable to the user. The process of negotiation will typically conclude after a few, e.g., 1, 2 or 3, iterations. The process of negotiation can repeat indefinitely (can have any number of iterations). The system can halt the process of negotiation after a predetermined number of iterations. If agreement is reached regarding the price/discount, then the user can enter the restaurant and purchase the meal.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

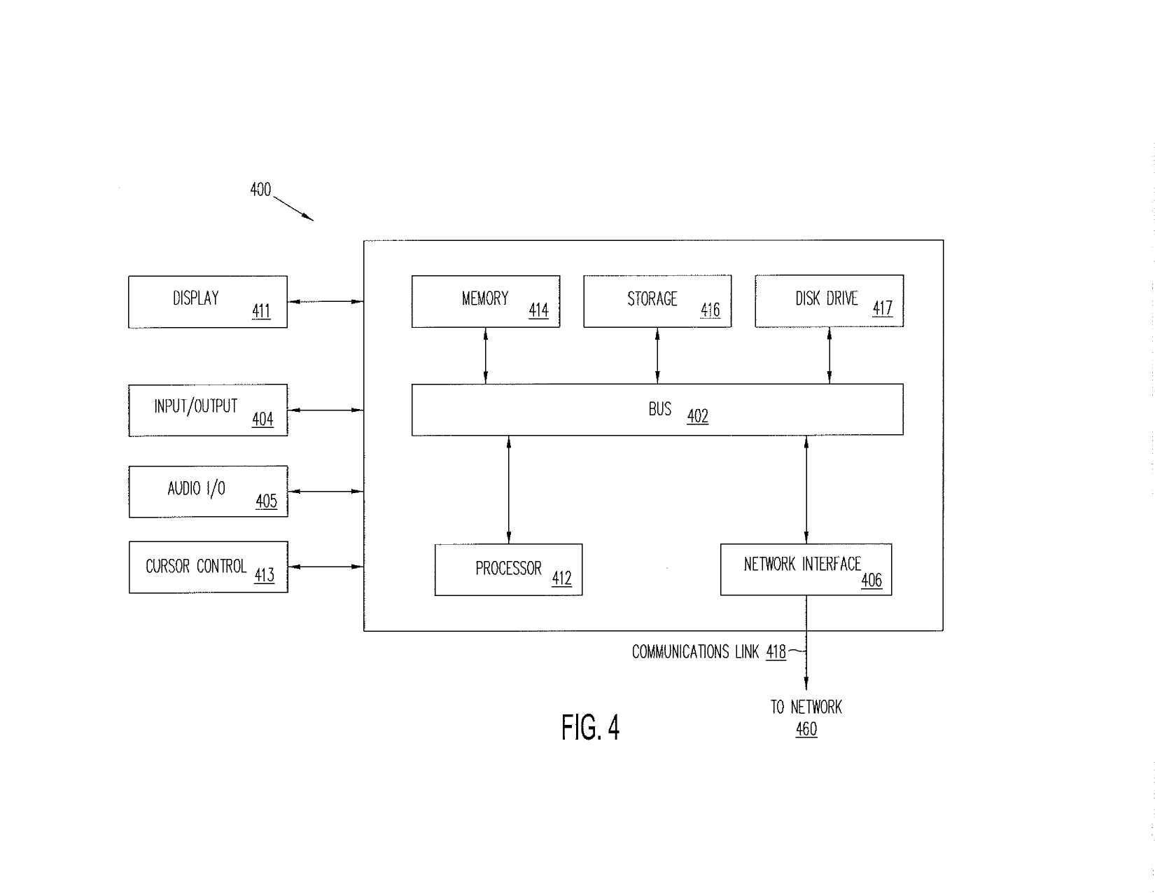

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (110) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The methods and systems disclosed herein provide users with an opportunity to purchase advertised products before the impact of the advertisements have been substantially reduced by the passage of time. Thus, the effectiveness of the advertising is substantially enhanced and consequently the cost of such advertising per unit of sales is desirably reduced. The methods and systems disclosed herein allow users and merchants to negotiate a mutually acceptable price/discount for products. In this manner, the user can obtain a more favorable price/discount and the merchant can obtain a customer.

As used herein, the term “store” can include any business or place of business. The store can be a brick and mortar store or an online store. The store can be any person or entity that sells a product. Rather than being near the store, the user can be near any other predetermined thing. For example, the user can be near a competitor's store and the advertisement can encourage the user to shop at a merchant's online store rather than at the competitor's store.

As used herein, the term “product” can include any item or service. A product can be anything that can be sold.

As used herein, the term “merchant” can include any seller of products. The term merchant can include a store. The products can be sold from a store or in any other manner.

As used herein, the terms “near” and “proximate”, can refer to a distance or a time. For example, the user can be near or proximate the merchant when the user is within one, two, three, four, five, six, or more blocks of the merchant when the user is walking and can be near or proximate the merchant when the user is within one, two, three, four, or more miles of the merchant when the user is traveling in an automobile. As a further example, the user can be near or proximate the merchant when the user can see the merchant. As a further example, the user can be near or proximate the merchant when the user device 120 is within WiFi or WiMAX range of the merchant device. As a further example, the user can be near or proximate the merchant when the user is within one, two, three, four, five, six, seven, eight, nine, or ten minutes of merchant (such as when walking at approximately two to four miles per hour or traveling by automobile at legal speed limits).

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
a memory storing account information for a user in a user account, the account information including an indication of a desire of the user to receive advertisements from a merchant when the user is proximate the merchant;
one or more processors operable to:
receive a communication including an indication of the user being proximate the merchant and information regarding an advertisement from the merchant, the information regarding the advertisement including an incentive;
access the user account;
determine from the user account if the user desires to receive the advertisement;
facilitate communication of the advertisement to the user if the user desires to receive the advertisement; and
facilitate negotiation of the incentive between the user and the merchant.

2. The system of claim 1, wherein the processor(s) are operable to automatically negotiate the price/discount on behalf of the user.

3. The system of claim 1, wherein the processor(s) are operable to automatically negotiate the price/discount on behalf of the merchant.

4. The system of claim 1, wherein the processor(s) are operable to automatically negotiate the price/discount on behalf of both the user and the merchant.

5. The system of claim 1, wherein the account information specifies from what merchants the user desires to receive advertisements.

6. The system of claim 1, wherein the account information specifies for what products the user desires to receive advertisements.

7. The system of claim 1, wherein the account information specifies from what merchant locations the user desires to receive advertisements.

8. The system of claim 1, wherein the account information specifies at what times the user desires to receive advertisements.

9. The system of claim 1, wherein the account information specifies how much of a discount is required by the user.

10. The system of claim 1, wherein the advertisement is communicated to the user via text.

11. The system of claim 1, wherein the advertisement is communicated to the user via voice.

12. The system of claim 1, wherein the user is invited to view a web site of the merchant.

13. The system of claim 1, wherein the processor(s) are further operable to:
access a merchant account; and
deter mine from the merchant account if the merchant is presently open; and
communicate the advertisement to the user only when the merchant is open.

14. The system of claim 1, wherein the processor(s) are further operable to:
access a merchant account;
determine from the merchant account if the merchant is presently open; and
communicate the advertisement to the user when the merchant is closed, wherein the advertisement comprises hours during which the merchant is open.

15. The system of claim 1, wherein the advertisement is communicated to a mobile device of the user.

16. The system of claim 1, wherein the advertisement is communicated to an app of a mobile device of the user.

17. A method comprising:
storing, in a memory, account information for a user in a user account, the account information including an indication of a desire of the user to receive advertisements from a merchant when the user is proximate the merchant;
receiving, electronically by one or more processors, a communication including an indication of the user being proximate the merchant and information regarding an advertisement from the merchant, the information regarding the advertisement including an incentive;
accessing, by the processor(s), the user account;
determining, by the processor(s), from the user account if the user desires to receive the advertisement;
facilitating, by the processor(s), communication of the advertisement to the user if the user desires to receive the advertisement; and
facilitating, by the processor(s), negotiation of the incentive between the user and the merchant.

18. The method of claim 17, wherein the processor(s) are operable to automatically negotiate the price/discount on behalf of the user.

19. The method of claim 17, wherein the processor(s) are operable to automatically negotiate the price/discount on behalf of the merchant.

20. A computer program product comprising a non-transitory computer readable medium having computer readable and executable code for instructing a processor to perform a method, the method comprising:
storing, in a memory, account information for a user in a user account, the account information including an indication of a desire of the user to receive advertisements from a merchant when the user is proximate the merchant;
receiving, electronically by one or more processors, a communication including an indication of the user being proximate the merchant and information regarding an advertisement from the merchant, the information regarding the advertisement including an incentive;
accessing, by the processor(s), the user account;
determining, by the processor(s), from the user account if the user desires to receive the advertisement;
facilitating, by the processor(s), communication of the advertisement to the user if the user desires to receive the advertisement; and
facilitating, by the processor(s), negotiation of the incentive between the user and the merchant.
